(19) United States
(12) Patent Application Publication
(10) Pub. No.: US 2014/0297277 A1
(43) Pub. Date: Oct. 2, 2014

(54) Systems and Methods for Automated Scoring of Spoken Language in Multiparty Conversations

(71) Applicant: Educational Testing Service, Princeton, NJ (US)

(72) Inventors: Klaus Zechner, Princeton, NJ (US); Keelan Evanini, Pennington, NJ (US)

(73) Assignee: Educational Testing Service, Princeton, NJ (US)

(21) Appl. No.: 14/226,010

(22) Filed: Mar. 26, 2014

Related U.S. Application Data
(60) Provisional application No. 61/806,001, filed on Mar. 28, 2013.

(51) Int. Cl. G10L 15/08; G10L 15/26

(52) U.S. Cl. CPC G10L 15/08; G10L 15/26
USPC 704/235; 704/254

(57) ABSTRACT

Systems and methods are provided for scoring spoken language in multiparty conversations. A computer receives a conversation between an examinee and at least one interlocutor. The computer selects a portion of the conversation. The portion includes one or more examinee utterances and one or more interlocutor utterances. The computer assesses the portion using one or more metrics, such as: a pragmatic metric for measuring a pragmatic fit of the one or more examinee utterances; a speech act metric for measuring a speech act appropriateness of the one or more examinee utterances; a speech register metric for measuring a speech register appropriateness of the one or more examinee utterances; and an accommodation metric for measuring a level of accommodation of the one or more examinee utterances. The computer computes a final score for the portion of the conversation based on the one or more metrics applied.

Applicant claims benefit pursuant to 35 U.S.C. §119 and hereby incorporates by reference the following U.S. Provisional Patent Application in its entirety: “AUTOMATED SCORING OF SPOKEN LANGUAGE IN MULTIPARTY CONVERSATIONS,” App. No. 61/806,001, filed Mar. 28, 2013.

### FIELD

The technology described herein relates generally to automated language assessment and more specifically to automatic assessment of spoken language in a multiparty conversation.

### BACKGROUND

Assessment of a person's speaking proficiency is often performed in education and in other domains. One aspect of speaking proficiency is communicative competence, such as a person's ability to adequately converse with one or more interlocutors (who may be human dialog partners or computer programs designed to be dialog partners). The skills involved in contributing adequately, appropriately, and meaningfully to the pragmatic and propositional context and content of the dialog situation is often overlooked. Even in situations where conversational skills are assessed, the assessment is often performed manually, which is costly, time-consuming, and lacks objectivity.

### SUMMARY

In accordance with the teachings herein, computer-implemented systems and methods are provided for automatically scoring spoken language in multiparty conversations. For example, a computer performing the scoring of multi-party conversations can receive a conversation between an examinee and at least one interlocutor. The computer can select a portion of the conversation. The portion includes one or more examinee utterances and one or more interlocutor utterances. The computer can assess the portion using one or more metrics, such as: a pragmatic metric for measuring a pragmatic fit of the one or more examinee utterances; a speech act metric for measuring a speech act appropriateness of the one or more examinee utterances; a speech register metric for measuring a speech register appropriateness of the one or more examinee utterances; and an accommodation metric for measuring a level of accommodation of the one or more examinee utterances. The computer can compute a final score for the portion of the conversation based on at least the one or more metrics applied.

### BRIEF DESCRIPTION OF THE DRAWINGS

FIG. 1 depicts a computer-implemented environment for automatically assessing a spoken conversation.

FIG. 2 is a flow diagram depicting a method of assessing an examinee's conversation with one or more interlocutors.

FIG. 3 is a flow diagram depicting a method of assessing the pragmatic fit of an examinee's utterances in a conversation.

FIG. 4 is a flow diagram depicting a method of assessing the speech act appropriateness of an examinee's utterances in a conversation.

FIG. 5 is a flow diagram depicting a method of assessing the speech register appropriateness of an examinee's utterances in a conversation.

FIG. 6 is a flow diagram depicting a method of assessing the level of accommodation of an examinee's utterances in a conversation.

FIGS. 7A, 7B, and 7C depict example systems for implementing an automatic conversation assessment engine.

### DETAILED DESCRIPTION

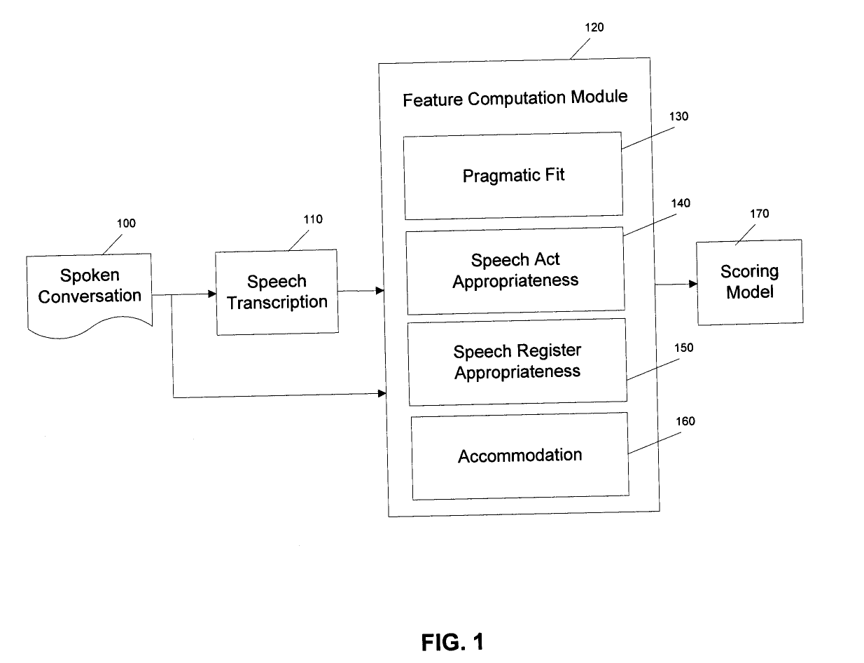

FIG. 1 is a block diagram depicting one embodiment of a computer-implemented environment for automatically assessing the proficiency of a spoken conversation 100. The spoken conversation 100 includes spoken utterances between an examinee (i.e., a user whose communicative competence is being assessed) and one or more interlocutors (which could be humans or computer implemented intelligent agents). In one embodiment, the conversation occurs within the context of a goal-oriented communicative task in which the examinee and the interlocutor(s) each assumes a role in the interaction. The interlocutor(s) may provide information to the examinee and/or ask questions, and the examinee would be expected to respond appropriately in order to accomplish the desired goals. Some examples of possible communicative tasks include: (1) a student (examinee) asking for a librarian's (interlocutor) help to locate a specific book; (2) a tourist (examinee) asking a local resident (interlocutor) for directions; and (3) a student (examinee) asking other students (interlocutors) what the homework assignment is. The spoken conversation 100 that takes place can be captured in any format (e.g., analog or digital).

The spoken conversation 100 is then converted into textual data at 110. In one embodiment, the conversion is performed by automatic speech recognition software, well known in the art. The conversion may also be performed manually (e.g., via human transcription) or any other methods known in the art.

Once converted, the conversation is processed by a feature computation module 120, which has access to both the original audio information as well as the converted textual information. The computation module 120 computes a set of features addressing, for example, pragmatic competence and other aspects of the examinee's conversational proficiency. In one embodiment, a pragmatic fit metric 130 is used to analyze the pragmatic adequacy of the examinee's utterances. A speech act appropriateness metric 140 may be used to analyze whether the examinee is appropriately using and interpreting speech acts. Since different sociolinguistic relationships may call for different speech patterns, a speech register appropriateness metric 150 may be used to analyze whether the examinee is speaking appropriately given his character's sociolinguistic relationship with the interlocutor(s). In addition, an accommodation metric 160 may be used to measure the level of accommodation exhibited by the examinee to accommodate the speech patterns of the interlocutor(s).

After the feature computation module 120 has analyzed the various features of the examinee's utterances, a scoring model 170 uses the results of the various metrics to predict a score reflecting an assessment of the examinee's communicative competence. Different weights may be applied to the metric results according to their perceived relative importance.

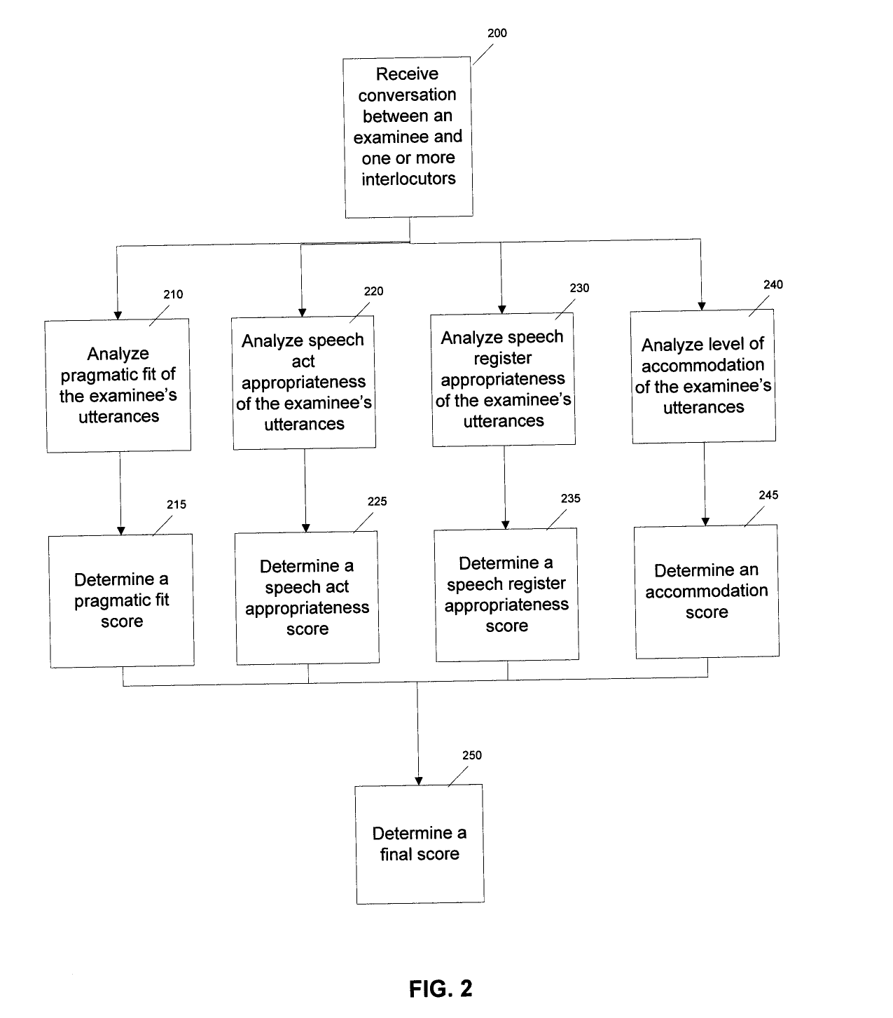

FIG. 2 is a flow diagram depicting an embodiment for assessing an examinee's conversation with one or more interlocutors. At 200, the system implementing the method receives a conversation between an examinee and one or more interlocutors. The received conversation may be in textual format (e.g., a transcript of the conversation) or audio format, in which case it may be converted into textual format (e.g., using automatic speech recognition technology). The examinee's utterances in the conversation may be analyzed for correctness or appropriateness in terms of their pragmatic fit (at 210), speech act (at 220), speech register (at 230), and/or level of accommodation (at 240). Depending on which of the features are analyzed, a corresponding pragmatic fit score (at 215), speech act appropriateness score (at 225), speech register appropriateness score (at 235), and/or accommodation score (at 245) may be determined. At 250, the scores for the features analyzed are then used to determine a final score for the examinee's performance in the conversation. In one embodiment, the final score may be based on additional linguistic features, such as fluency, prosody, pronunciation, vocabulary, and grammatical appropriateness.

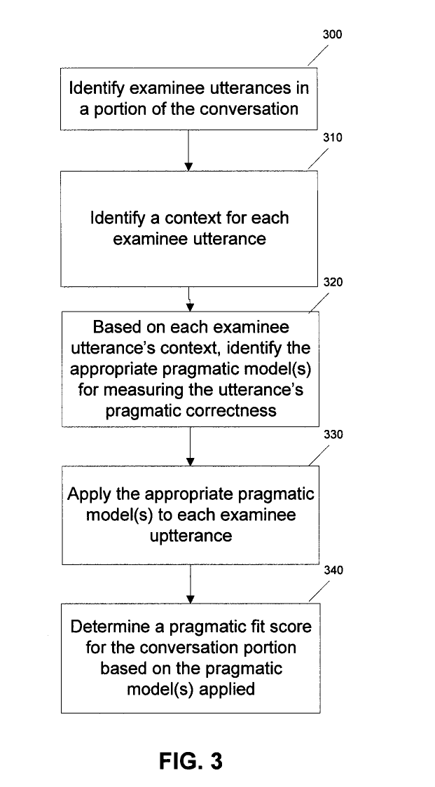

FIG. 3. depicts an embodiment for assessing the pragmatic fit of an examinee's utterances in a conversation. At 300, the examinee's utterances in a portion of the conversation are identified (a portion of the conversation may also be the entire conversation). In one embodiment, an examinee's utterance may be any portion of his speech. In another embodiment, an examinee utterance is an instance of continuous speech that is flanked by someone else's (e.g., the interlocutor's) utterances. In one embodiment, the examinee's utterances are identified as needed, instead of identified from the outset before any pragmatic fit analysis takes place (i.e., each examinee utterance is identified and analyzed before the next utterance is identified and analyzed).

At 310, each examinee utterance's context is determined. A context, for example, may be one or more immediately preceding utterances made by the interlocutor(s) and/or the examinee. The context may also include the topic or setting of the conversation or any other indication as to what utterance can be expected given that context.

At 320, one or more pragmatic models are identified based on the context of each examinee utterance. The context, which may be a preceding interlocutor utterance, helps the system determine what utterances are expected in that context. For example, if the context is the interlocutor saying, “How are you?”, an expected utterance may be, “I am fine.” Thus, based on the context, the system can determine which pragmatic model to use to analyze the pragmatic fit of the examinee's utterance in that context. The expected utterances may be predetermined by human experts or via supervised learning.

The pragmatic models may be implemented by any means. For example, a pragmatic model may involve calculating the edit distance between the examinee utterance and one or more expected utterances. Another example of a pragmatic model may involve using formal languages (e.g., regular expressions or context free grammars) that model one or more expected utterances.

At 330, the identified one or more pragmatic models, which are associated with a given context, are applied to the examinee's utterance associated with that same context. Extending the exemplary implementations discussed in the paragraph immediately above, this step may involve calculating an edit distance between the examinee's utterance and each expected utterance, and/or matching the examinee's utterance against each regular expression.

At 340, the results of applying the pragmatic models are used to determine a pragmatic fit score for the portion of conversation from which the examinee's utterances are sampled from. The pragmatic fit score for the portion of conversation selected may be determined, for example, based on scores given to individual examinee utterances in that portion of conversation (e.g., the pragmatic fit score may be an average of the scores of the individual examinee utterances). As for the score for each examinee utterance, it may, for example, be based on the results of one or more different pragmatic models applied to that examinee utterance (e.g., the score for an examinee utterance may be an average between the edit distance result and regular expression result). The manner in which the result of a pragmatic model is determined depends on the nature of the model. Take for example the edit distance pragmatic model described above. Each expected utterance may have an associated correctness weight depending on how well the expected utterance fits in the given context. Based on the calculated edit distances between the examinee's utterance and each of the expected utterances, a best match is determined. The correctness weight of the best-matching expected utterance, for example, may then be the result of applying the edit distance model. The result of the regular expression model may similarly be based on the correctness weight associated with a best-matching regular expression.

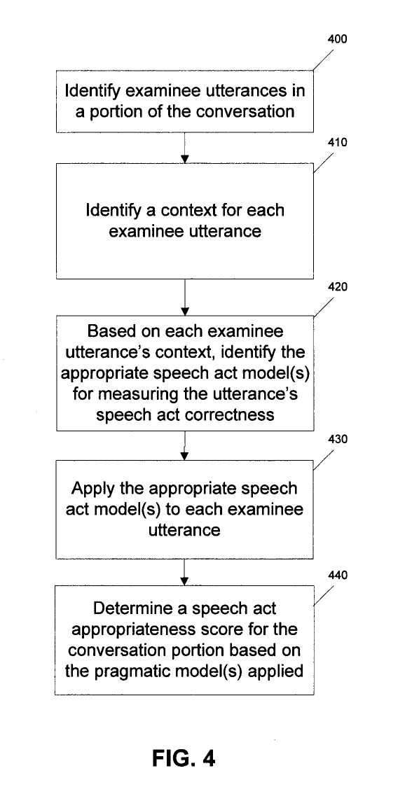

FIG. 4 depicts an embodiment for assessing the speech act appropriateness of an examinee's utterances in a conversation. At 400, the examinee's utterances in a portion of the conversation are identified. In one embodiment, the examinee's utterances are identified as needed, instead of identified from the outset before any speech act analysis takes place.

At 410, each examinee utterance's context is determined. The context may be any indication as to what speech act can be expected given that context (e.g., one or more preceding utterances by the interlocutor and/or examinee). For a given examinee utterance, the context determined for the speech act analysis may or may not be the same as the context determined for the pragmatic fit analysis described above.

At 420, one or more speech act models are identified based on the context of each examinee utterance. The context helps the system determine what speech acts are expected. Thus, based on the context, the system can determine which speech act model to use to analyze the appropriateness of the examinee's speech act in that context.

The speech act models may be implemented by any means and focused on different linguistic features. For example, lexical choice, grammar, and intonation may all provide cues for speech acts. Thus, the identified speech act models may analyze any combination of linguistic features when comparing the examinee utterance with the expected speech acts. The model may utilize any linguistic comparison or extraction tools, such as formal languages (e.g., regular expressions or context free grammars) and speech act classifiers.

At 430, the identified one or more speech act models, which are associated with a given context, are applied to the examinee's utterance associated with that same context. Then at 440, the results of applying the speech act models are used to determine a speech act appropriateness score for the portion of conversation from which the examinee's utterances are sampled from. The speech act appropriateness score for the portion of conversation selected may be determined, for example, based on scores given to individual examinee utterances in that portion of conversation (e.g., the speech act appropriateness score may be an average of the scores of the individual examinee utterances). The score for each individual examinee utterance may, for example, be based on the results of one or more speech act models applied to that examinee utterance (e.g., the score for an examinee utterance may be an average of the speech act model results). With respect to the result of an individual speech act model, in one embodiment the result is proportional to the correctness weight associated with each expected speech act.

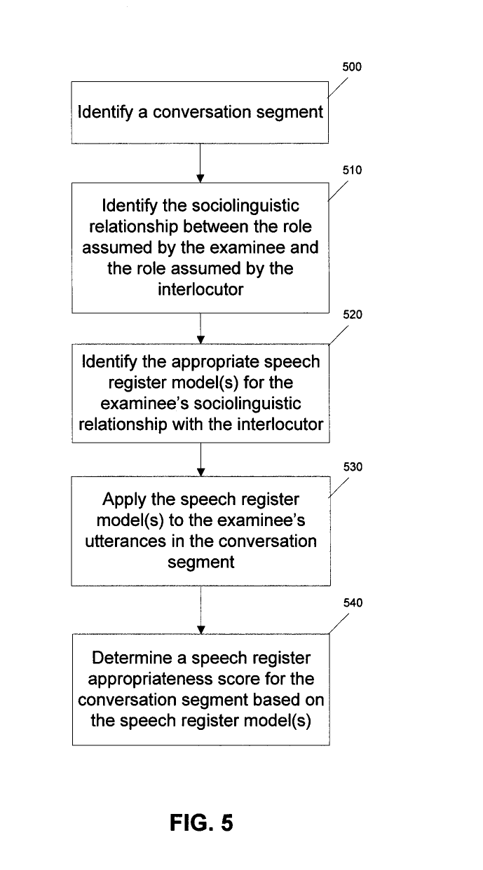

FIG. 5 depicts an embodiment for assessing the speech register appropriateness of an examinee's utterances in a conversation. At 500, a portion of the conversation is identified. Within the defined portion of the conversation, the sociolinguistic relationship between the role assumed by the examinee and the role assumed by the interlocutor is identified (at 510). Based on the sociolinguistic relationship, particular speech registers (e.g., formality or politeness level) are expected of the examinee's utterances. For example, the speech register expected of a student would be different from the speech register expected of a teacher. Thus, at 520 the appropriate speech register model(s) are identified based on the sociolinguistic relationship. In one embodiment, each speech register model may represent a linguistic feature (e.g., grammatical construction, lexical choices, intonation, prosody, pronunciation, tone, pauses, rate of speech, etc.) that conforms to the expected speech register(s). At 530, each speech register model is compared to the examinee utterance to determine how well the utterance conforms to the expected speech register.

Then at 540, based on the comparison results, a speech register appropriateness score for the selected conversation portion is determined. The speech register appropriateness score may be determined, for example, based on scores given to individual examinee utterances in that portion of conversation (e.g., the speech register appropriateness score may be an average of the scores of the individual examinee utterances). The score for each individual examinee utterance may, for example, be based on the results of one or more speech register models applied to that examinee utterance (e.g., the score for an examinee utterance may be an average of the speech register model results). With respect to the result of an individual speech register model, in one embodiment the result is proportional to the correctness weight associated with each expected speech register.

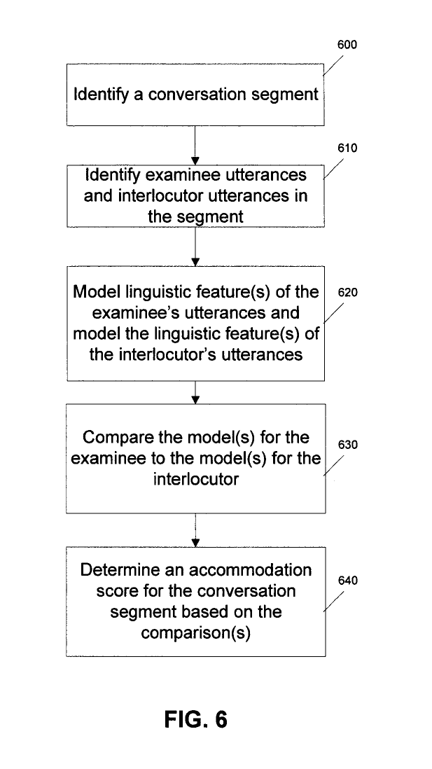

FIG. 6 depicts an embodiment for assessing the level of accommodation the examinee exhibited in the conversation, which is based on the observation that people engaged in conversation typically accommodate their speech patterns in order to facilitate communication. Therefore, the idea is to compare an examinee's speech pattern to that of the interlocutor(s) to measure the examinee's level of accommodation. The amount by which the examinee modifies his speech pattern throughout the course of the conversation will be scored.

At 600, a portion of the conversation is identified. At 610, examinee utterances and interlocutor utterances are identified within the conversation portion. In one embodiment, a relationship between the examinee utterances and interlocutor utterances may also be identified so that each examinee utterance is compared to the proper corresponding interlocutor utterance(s). The relationship may be based on time (e.g., utterances within a time frame are compared), chronological sequence (e.g., each examinee utterance is compared with the preceding interlocutor utterance(s)), or other associations.

At 620, one or more linguistic features (e.g., grammatical construction, lexical choice, pronunciation, prosody, rate of speech, and intonation) of the examinee utterances are modeled, and the same or related linguistic features of the interlocutor utterances are similarly modeled. At 630, each examinee model is compared with one or more corresponding interlocutor models. For example, the examinee models and interlocutor models that are related to rate of speech are compared, and the models that are related to intonation are compared. In one embodiment, each model is also associated with an utterance, and the model for an examinee utterance is compared to the model for an interlocutor utterance associated with that examinee utterance. In another embodiment, comparison is made between an examinee model representing a linguistic pattern of the examinee's utterance over time, and an interlocutor model representing a linguistic pattern of the interlocutor's utterance over the same time period. Then at 640, based on the comparison results an accommodation score for the selected conversation portion is determined.

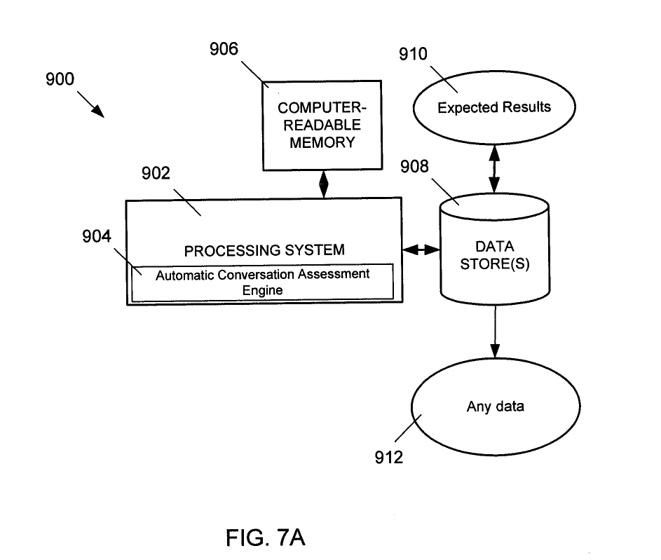

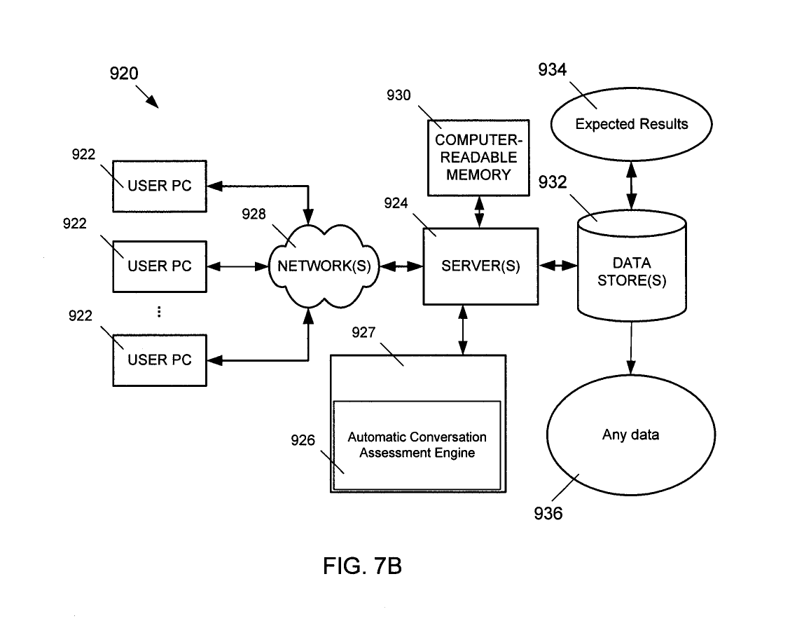

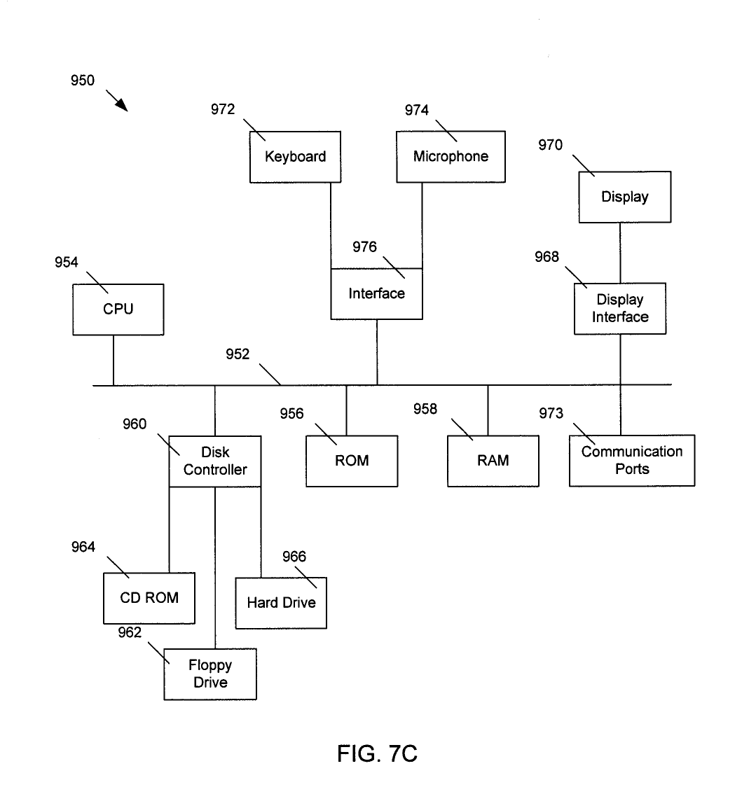

FIGS. 7A, 7B, and 7C depict example systems for use in implementing an automated conversation scoring engine. For example, FIG. 7A depicts an exemplary system 900 that includes a stand-alone computer architecture where a processing system 902 (e.g., one or more computer processors) includes an automated recitation item generation engine 904 (which may be implemented as software). The processing system 902 has access to a computer-readable memory 906 in addition to one or more data stores 908. The one or more data stores 908 may contain a pool of expected results 910 as well as any data 912 used by the modules or metrics.

FIG. 7B depicts a system 920 that includes a client server architecture. One or more user PCs 922 accesses one or more servers 924 running an automated conversation scoring engine 926 on a processing system 927 via one or more networks 928. The one or more servers 924 may access a computer readable memory 930 as well as one or more data stores 932. The one or more data stores 932 may contain a pool of expected results 934 as well as any data 936 used by the modules or metrics.

FIG. 7C shows a block diagram of exemplary hardware for a standalone computer architecture 950, such as the architecture depicted in FIG. 7A, that may be used to contain and/or implement the program instructions of exemplary embodiments. A bus 952 may serve as the information highway interconnecting the other illustrated components of the hardware. A processing system 954 labeled CPU (central processing unit) (e.g., one or more computer processors), may perform calculations and logic operations required to execute a program. A computer-readable storage medium, such as read only memory (ROM) 956 and random access memory (RAM) 958, may be in communication with the processing unit 954 and may contain one or more programming instructions for performing the method of implementing an automated conversation scoring engine. Optionally, program instructions may be stored on a non-transitory computer readable storage medium such as a magnetic disk, optical disk, recordable memory device, flash memory, RAM, ROM, or other physical storage medium. Computer instructions may also be communicated via a communications signal, or a modulated carrier wave and then stored on a non-transitory computer-readable storage medium.

A disk controller 960 interfaces one or more optional disk drives to the system bus 952. These disk drives may be external or internal floppy disk drives such as 962, external or internal CD-ROM, CD-R, CD-RW or DVD drives such as 964, or external or internal hard drives 966. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 960, the ROM 956 and/or the RAM 958. Preferably, the processor 954 may access each component as required.

A display interface 968 may permit information from the bus 952 to be displayed on a display 970 in audio, graphic, or alphanumeric format. Communication with external devices may optionally occur using various communication ports 973.

In addition to the standard computer-type components, the hardware may also include data input devices, such as a keyboard 972, or other input device 974, such as a microphone, remote control, pointer, mouse and/or joystick.

The invention has been described with reference to particular exemplary embodiments. However, it will be readily apparent to those skilled in the art that it is possible to embody the invention in specific forms other than those of the exemplary embodiments described above. The embodiments are merely illustrative and should not be considered restrictive. The scope of the invention is reflected in the claims, rather than the preceding description, and all variations and equivalents which fall within the range of the claims are intended to be embraced therein.

It is claimed:

1. A computer-implemented method of assessing communicative competence, the method comprising:
receiving a conversation between an examinee and at least one interlocutor;
selecting a portion of the conversation, wherein the portion includes one or more examinee utterances and one or more interlocutor utterances;
assessing the portion using one or more metrics selected from the group consisting of:
pragmatic metric for measuring a pragmatic fit of the one or more examinee utterances;
speech act metric for measuring a speech act appropriateness of the one or more examinee utterances;
speech register metric for measuring a speech register appropriateness of the one or more examinee utterances; and
accommodation metric for measuring a level of accommodation of the one or more examinee utterances;
computing a final score for the portion of the conversation based on at least the one or more metrics applied.

2. The method of claim 1, wherein the conversation is in audio format, the method further comprising:
converting the conversation into text format.

3. The method of claim 1, wherein the conversation is in text format.

4. The method of claim 1, wherein the portion of the conversation is the entire conversation.

5. The method of claim 1, wherein computing a final score includes applying one or more weights to the one or more metrics applied.

6. The method of claim 1, wherein computing a final score includes analyzing one or more linguistic features of the one or more examinee utterances, wherein the one or more linguistic features are selected from the group consisting of fluency, pronunciation, prosody, vocabulary, and grammar appropriateness.

7. The method of claim 1, wherein the pragmatic metric includes:
identifying a context of each of the one or more examinee utterances;
determining one or more expected utterance models associated with the context of each of the one or more examinee utterances; and
applying to each of the one or more examinee utterances the one or more expected utterance models associated with the context of that examinee utterance.

8. The method of claim 7, wherein the context for an examinee utterance includes one or more preceding utterances.

9. The method of claim 7, wherein the one or more expected utterance models define pragmatically adequate utterances in the associated context.

10. The method of claim 7, wherein the one or more expected utterance models include a metric for comparing an examinee utterance with one or more pragmatically adequate utterances in the associated context.

11. The method of claim 1, wherein the speech act metric includes:
identifying a context of each of the one or more examinee utterances;
determining one or more appropriate speech act models associated with the context of each of the one or more examinee utterances; and
applying to each of the one or more examinee utterances the one or more appropriate speech act models associated with the context of that examinee utterance.

12. The method of claim 11, wherein the context of an examinee utterance includes one or more preceding utterances.

13. The method of claim 11, wherein the one or more appropriate speech act models define speech acts expected in the associated context.

14. The method of claim 11, wherein the one or more appropriate speech act models include a metric for comparing an examinee utterance with one or more speech acts expected in the associated context.

15. The method of claim 11, wherein the one or more appropriate speech act models include a metric for comparing an intonation of an examinee utterance with one or more expected intonations.

16. The method of claim 1, wherein the speech register metric includes:
identifying a sociolinguistic relationship between a role assumed by the examinee and at least one role assumed by the at least one interlocutor;
determining one or more expected speech register models based on the sociolinguistic relationship; and
applying the one or more expected speech register models to the one or more examinee utterances.

17. The method of claim 16, wherein the one or more expected speech register models include analyzing one or more linguistic features of the one or more examinee utterances to determine whether the one or more examinee utterances are of one or more expected speech registers.

18. The method of claim 17, wherein the one or more linguistic features include grammatical construction, lexical choice, intonation, prosody, tone, pauses, rate of speech, or pronunciation.

19. The method of claim 1, wherein each examinee utterance has an associated interlocutor utterance, and wherein the accommodation metric includes:
identifying one or more linguistic features;
modeling the one or more linguistic features of the one or more examinee utterances, thereby generating an examinee utterance model for each linguistic feature of each examinee utterance;
modeling the one or more linguistic features of the one or more interlocutor utterances, thereby generating an interlocutor utterance model for each linguistic feature of each interlocutor utterance; and
for each linguistic feature, comparing the associated examinee utterance model for each examinee utterance to the associated interlocutor utterance model for the interlocutor utterance associated with that examinee utterance.

20. The method of claim 19, wherein the one or more linguistic features include grammatical construction, lexical choice, pronunciation, prosody, rate of speech, or intonation.
